(19) United States
(12) Patent Application Publication
(10) Pub. No.: US 2010/0034532 A1
(43) Pub. Date: Feb. 11, 2010

(54) Communications Network

(76) Inventors: Paolo Ghelfi, Goito (IT); Filippo Cuglini, Fidenza (IT); Tomasz Rogowski, Wroclaw (PL); Piero Castoldi, Parma (IT); Rodolfo Di Muro, Coventry West Midlands (GB); Bimal Nayar, Milton Keynes Bedfordshire (GB); Karin Essner, Pisa (IT)

Correspondence Address: COATS & BENNETT, PLLC, 1400 Crescent Green, Suite 300, Cary, NC, 27518, US

(21) Appl. No.: 12/440,778

(22) PCT Filed: Sep. 11, 2006
(86) PCT No.: PCT/EP06/66222

§ 371 Date: Oct. 15, 2009

(51) Int. Cl. H04J 14/00; H04B 10/08; H04B 17/00

(52) U.S. Cl. 398/2; 398/48; 398/19

(57) ABSTRACT

The invention relates to a communications node (10, 90, 100) for routing a plurality of Wavelength Division Multiplexed (WDM) optical signals, the node having a plurality of line units (12) between its inputs and outputs, each line unit including a splitter (14) and a Wavelength Selective Switch (WSS) (16), wherein the splitter (14) is arranged to split an incoming WDM signal into a plurality of WDM signals and to pass them to each WSS in the plurality of line units, each WSS (16) being arranged to selectively route any one or more channels of its received WDM signals to its associated output. Such an arrangement has the advantage of providing a more cost effective realisation of a node with a high nodal degree. The invention provides a technical solution to the problem of connecting a plurality of inputs to a plurality of outputs in a multi-port WDM node. The node has particular application in a mesh network where the nodal degree may be high. Using WSS technology avoids the requirement for many blockers to be used due to the inherent capability of WSSs to selectively block input channels.

The invention relates to a communications network and in particular, but not exclusively, to a node of a communications network, and methods and software for operation thereof.

Known communications networks operating using Wavelength Division Multiplexing (WDM) include nodes to add or drop optical signals to or from the network, that is add or drop individual wavelengths carrying data to or from the network. Such nodes may be arranged in a ring network in which the nodes are connected by optical fibres in series such as to form a closed loop or ring. To provide protection in the event of a fibre break occurring, two fibre optical rings connecting the nodes are provided, and the same WDM traffic is routed in opposite directions around their respective ring. An optical cross connect within a node allows individual wavelengths carrying data to be routed on the different line directions and to be routed onto different ring networks connected to said node. The cross connect can also selectively terminate wavelengths as required.

The most common architecture for such a node is a Reconfigurable Optical Add/Drop Multiplexer (ROADM) arrangement that has a plurality of ports corresponding to the plurality of line directions, each port being able to pass an incoming and outgoing WDM optical signal. A node having two ports is said to have a nodal degree of two.

Next generation networks require ROADMs with a higher nodal degree such that there are a larger number of adjacent nodes to transform ring networks into mesh networks. A node in a next generation network must also be able to switch any input channel, entering the node at any input port, to any output port. Moreover, nodes with improved flexibility are needed, so that they can be remotely reconfigured via a Management Plane or a Control Plane when necessary. Such remote reconfigurability reduces capital expenditure and improves the long-term profitability of the network by reducing operational costs.

The known ROADM is generally based on a broadcast and select architecture, where the WDM signal entering the node on one port is broadcast to other line directions in the form of secondary WDM signals using a splitter. A device capable of suppressing each wavelength separately, known as a wavelength blocker, then intercepts each secondary WDM signal, in order to block the unwanted channels and to select only the channels to be transmitted. A coupler then collects the channels to be forwarded towards each output port. The add and drop function at the node is generally realized using multiplexer/demultiplexer devices such as Arrayed Waveguide Gratings (AWGs) connected to a plurality of transponders. This node architecture requires a plurality of wavelength blockers that is proportional to ND×(ND−1), where ND is the Nodal Degree. A ROADM with a Nodal Degree of 3 requires 6 wavelength blockers, whereas a ROADM with a Nodal Degree of 4 requires 12 wavelength blockers. In this way the known ROADM does not allow a cost effective realisation for a nodal degree higher than 3.

The present invention aims, in at least one of its embodiments, to solve or at least ameliorate the problems of the known arrangement by providing an architecture that permits a more reliable node, and a cost effective realisation of a node having a higher nodal degree.

According to a first aspect of the invention, there is provided a communications node for routing a plurality of Wavelength Division Multiplexed (WDM) optical signals, the node having a plurality of inputs and a plurality of outputs, each input associated with a respective output, each associated input and output having a line unit between them, each line unit including a splitter and a Wavelength Selective Switch (WSS), wherein the splitter is arranged to split an incoming WDM signal into a plurality of WDM signals and to pass them to each WSS in the plurality of line units, each WSS being arranged to selectively route any one or more channels of its received WDM signals to its associated output.

Such an arrangement has the advantage of providing a more cost effective realisation of a node with a high nodal degree. The invention provides a technical solution to the problem of connecting a plurality of inputs to a plurality of outputs in a multi-port WDM node. The node has particular application in a mesh network where the nodal degree may be high. Using WSS technology avoids the requirement for many blockers to be used due to the inherent capability of WSSs to selectively block input channels.

In one embodiment at least one line unit has an output to one or more drop transponders for dropping channels from the node. Such an arrangement permits any channel from any WDM signal received at input to be dropped at the node.

Preferably at least one line unit has an input from one or more add transponders for adding channels to the node. Such an arrangement permits a channel to be added at the node and to be routed to any of the outputs. In this way it can be seen that the line unit can be used for many different purposes. The line unit is a functionally versatile part of the node and can be used for routing, adding or dropping channels.

Preferably the add transponders are arranged to change the wavelength of the channels added to the node, and in a preferred embodiment the add transponders have tuneable lasers to change the wavelength of the channels added to the node.

The node may have at least one backup unit having a backup WSS in communication with a backup switch, each line unit being further provided with a coupler between its WSS and its respective associated output, the backup WSS being arranged to accept WDM optical signals from each WSS of the plurality of line units, the backup switch having a plurality of outputs each of which is connected to the coupler of a respective one of the plurality of line units, wherein on failure of the WSS in one of the plurality of line units the backup WSS routes the WDM signal associated with the failed WSS to the coupler of the associated failed WSS using the backup switch.

Such a backup unit provides the advantage of permitting a failed WSS in any of the line units to be bypassed, and thereby provides resilience to node.

Preferably each line unit is further provided with a shutter between the WSS and the coupler to block unwanted signals from the failed WSS. The shutter inhibits any WDM signals from the failed WSS from interfering with the WDM signal from the backup unit.

In the case of the node having add or drop capability, one of the outputs of the backup switch is in communication with the line unit associated with adding or dropping channels from the node. Such an arrangement has the advantage of permitting the backup unit to bypass a failure of the WSS associated with the line unit for adding or dropping channels.

Preferably the WDM signals entering the backup WSS are blocked by the backup switch when each WSS of the node is functioning correctly. This ensures that WDM signals from the backup unit do not interfere with WDM signals in a correctly functioning line unit.

In one embodiment the WDM signals entering the backup WSS are blocked by a backup shutter located between the backup WSS and the backup switch when each WSS of the node is functioning correctly.

The at least one backup unit may serve the plurality of line units, or a subset of them.

Preferably each coupler has a 2×1 configuration. Such a coupler has two inputs and one output but it will be appreciated that the coupler may have an alternative configuration as required e.g. 3×1, 4×1, 3×2, 4×2 etc.

Preferably each line unit includes a basic line unit which comprises the splitter and the WSS of that line unit, and wherein the basic line unit is readily replaceable with another basic line unit. A basic line unit so arranged has the benefit of being readily removable with or without tools should a failure occur with the WSS of a particular line unit. The basic line unit is preferably a cartridge that can be put in place and pulled out as required. Optionally an indicator can be provided on the failed basic line unit or the node, such as a warning light, to visibly show that a failure has occurred.

The node may further including a management plane or a control plane for checking the available wavelengths during provisioning of an optical path between the plurality of inputs and the plurality of outputs to permit dropping of two or more channels at the node simultaneously at the same wavelength and entering the node at different inputs.

Preferably each WSS is arranged to be reconfigurable using the control plane or the management plane of a network in which the node is located.

Preferably the splitter and the WSS of at least one of the plurality of line units are provided with redundant outputs and inputs respectively. Such an arrangement allows the node to be readily upgradeable so that additional line units can be added by connecting them to the redundant outputs and inputs.

In another embodiment a first line unit has an output to at least one first regeneration transponder for regenerating at least one channel of a first WDM signal output from the first line unit, the first regeneration transponder having an output to one of the plurality of line units.

Such an arrangement permits a channel to be regenerated at the node and to be routed to any of the outputs. In this way it can be further seen that the line unit can be used for many different purposes and can be used for routing, adding or dropping channels, or regenerating channels.

Preferably the node further includes a second line unit to permit the node to regenerate bi-directional traffic, the second line unit having an output to at least one second regeneration transponder for regenerating at least one channel of a second WDM signal output from the second line unit, the second regeneration transponder having an output to one of the plurality of line units.

In a preferred embodiment the at least one first and second regeneration transponders are arranged to operate using 3R technology.

Preferably the first and second regeneration transponders are arranged to change the wavelength of the regenerated channels at the node, and in a preferred embodiment the first and second regeneration transponders have tuneable lasers to change the wavelength of the regenerated channels at the node.

In a preferred embodiment the output of the first line unit or the second line unit is in communication with the plurality of drop transponders to permit the first line unit or the second line unit to regenerate bi-directional traffic and to drop channels from the node. Such an arrangement provides a flexible node capable of performing multiple different functions.

Preferably the input to the first line unit or the second line unit is in communication with the add transponders to permit the first line unit or the second line unit to regenerate bi-directional traffic and to add channels to the node.

Preferably at least one, some, or each of the plurality of inputs has a respective input optical amplifier. Preferably at least one, some, or each of the plurality of outputs has a respective output optical amplifier. Such amplifiers can be used to ensure that the WDM signal has the correct input power and output power to and from the node respectively.

At least one, some, or each WSS may be realised using appropriate switching means such as a Micro Electro Mechanical Systems (MEMS) device or a Liquid Crystal device.

According to a second aspect the invention also provides a communications network including a node according to the first aspect of the invention.

According to a third aspect the invention also provides a method of dropping channels from a communications node (10, 90, 100), the node arranged for routing a plurality of Wavelength Division Multiplexed (WDM) optical signals and having a plurality of inputs and a plurality of outputs, each input associated with a respective output, each associated input and output having a line unit (12) between them, each line unit including a splitter (14) and a Wavelength Selective Switch (WSS) (16), wherein the splitter (14) is arranged to split an incoming WDM signal into a plurality of WDM signals and to pass them to each WSS in the plurality of line units, each WSS (16) being arranged to selectively route any one or more channels of its received WDM signals to its associated output, wherein at least one line unit (30) has an output to one or more drop transponders (43), the method including dropping channels from the node (10, 90, 100) at the one or more drop transponders (43).

According to a fourth aspect the invention also provides a method of adding channels to a communications node (10, 90, 100), the node arranged for routing a plurality of Wavelength Division Multiplexed (WDM) optical signals and having a plurality of inputs and a plurality of outputs, each input associated with a respective output, each associated input and output having a line unit (12) between, each line unit including a splitter (14) and a Wavelength Selective Switch (WSS) (16), wherein the splitter (14) is arranged to split an incoming WDM signal into a plurality of WDM signals and to pass them to each WSS in the plurality of line units, each WSS (16) being arranged to selectively route any one or more channels of its received WDM signals to its associated output, wherein at least one line unit (30) has an input from one or more add transponders (45), the method including adding channels to the node (10, 90, 100) at the one or more add transponders (45).

According to a fifth aspect the invention also provides a method of regenerating at least one channel of a WDM signal of a node (10, 90, 100), the node arranged for routing a plurality of Wavelength Division Multiplexed (WDM) optical signals and having a plurality of inputs and a plurality of outputs, each input associated with a respective output, each associated input and output having a line unit (12) between them, each line unit including a splitter (14) and a Wavelength Selective Switch (WSS) (16), wherein the splitter (14) is arranged to split an incoming WDM signal into a plurality of WDM signals and to pass them to each WSS in the plurality of line units, each WSS (16) being arranged to selectively route any one or more channels of its received WDM signals to its associated output, wherein a first line unit (92, 108) has an output to at least one first regeneration transponder (96, 98), the method including regenerating at least one channel of a first WDM signal output from the first line unit (92, 108), the first regeneration transponder (96, 98) having an output to one of the plurality of line units.

According to a sixth aspect the invention also provides a method of upgrading a communications node (10, 90, 100), the node arranged for routing a plurality of Wavelength Division Multiplexed (WDM) optical signals and having a plurality of inputs and a plurality of outputs, each input associated with a respective output, each associated input and output having a line unit (12) between them, each line unit including a splitter (14) and a Wavelength Selective Switch (WSS) (16), wherein the splitter (14) is arranged to split an incoming WDM signal into a plurality of WDM signals and to pass them to each WSS in the plurality of line units, each WSS (16) being arranged to selectively route any one or mores channel of its received WDM signals to its associated output, wherein each line unit (12) includes a basic line unit (42) which comprises the splitter (14) and the WSS (16) of that line unit (12), the method including providing the splitter and the WSS of at least one of the plurality of line units with redundant outputs and inputs respectively, and upgrading the node with an additional line unit by connecting it to the redundant outputs and inputs.

According to a seventh aspect the invention also provides software, or a computer program product, which when run on a computer processor of a communications node (10, 90, 100) for routing a plurality of Wavelength Division Multiplexed (WDM) optical signals and having a plurality of inputs and a plurality of outputs, each input associated with a respective output, each associated input and output having a line unit (12) between them, each line unit including a splitter (14) and a Wavelength Selective Switch (WSS) (16), wherein the splitter (14) is arranged to split an incoming WDM signal into a plurality of WDM signals and to pass them to each WSS in the plurality of line units, each WSS (16) being arranged to selectively route any one or more channels of its received WDM signals to its associated output, wherein at least one line unit (30) has an output to one or more drop transponders (43), the software for causing channels to be dropped from the node (10, 90, 100) at the one or more drop transponders (43).

According to an eighth aspect the invention also provides software, or a computer program product, which when run on a computer processor of a communications node (10, 90, 100) for routing a plurality of Wavelength Division Multiplexed (WDM) optical signals and having a plurality of inputs and a plurality of outputs, each input associated with a respective output, each associated input and output having a line unit (12) between them, each line unit including a splitter (14) and a Wavelength Selective Switch (WSS) (16), wherein the splitter (14) is arranged to split an incoming WDM signal into a plurality of WDM signals and to pass them to each WSS in the plurality of line units, each WSS (16) being arranged to selectively route any one or more channels of its received WDM signals to its associated output, wherein at least one line unit (30) has an input from one or more add transponders (45), the software for causing channels to be added to the node (10, 90, 100) at the one or more add transponders (45).

According to a ninth aspect the invention also provides software, or a computer program product, which when run on a computer processor of a communications node (10, 90, 100) for routing a plurality of Wavelength Division Multiplexed (WDM) optical signals and having a plurality of inputs and a plurality of outputs, each input associated with a respective output, each associated input and output having a line unit (12) between them, each line unit including a splitter (14) and a Wavelength Selective Switch (WSS) (16), wherein the splitter (14) is arranged to split an incoming WDM signal into a plurality of WDM signals and to pass them to each WSS in the plurality of line units, each WSS (16) being arranged to selectively route any one or more channels of its received WDM signals to its associated output, wherein a first line unit (92, 108) has an output to at least one first regeneration transponder (96, 98), the software for causing at least one channel of a first WDM signal output from the first line unit (92, 108) to be regenerated at the first regeneration transponder (96, 98), the regeneration transponder having an output to one of the plurality of line units.

According to a tenth aspect the invention also provides a method of compensating for failure in a communications node (10, 90, 100) for routing a plurality of Wavelength Division Multiplexed (WDM) optical signals, the node having a plurality of inputs and a plurality of outputs, each input associated with a respective output, each associated input and output having a line unit (12) between them, each line unit including a splitter (14) and a Wavelength Selective Switch (WSS) (16), wherein the splitter (14) is arranged to split an incoming WDM signal into a plurality of WDM signals and to pass them to each WSS in the plurality of line units, the method including arranging each WSS (16) to selectively route any one or more channels of its received WDM signals to its associated output, the node further including at least one backup unit (22) having a backup WSS (24) in communication with a backup switch (26), each line unit (12) being further provided with a coupler (20) between its WSS (16) and its respective associated output, the backup WSS (24) being arranged to accept WDM signals from each WSS (16) of the plurality of line units, the backup switch (26) having a plurality of outputs each of which is connected to the coupler (20) of a respective one of the plurality of line units, wherein the method includes detecting a failure of the WSS (16) in one of the plurality of line units the backup WSS (24) and arranging the node to route the WDM signal associated with the failed WSS to the coupler (20) of the associated failed WSS using the backup switch (26).

According to an eleventh aspect the invention also provides a method of dropping at least one channel from a communications node (10, 90, 100), the node arranged for routing a plurality of Wavelength Division Multiplexed (WDM) optical signals and having a plurality of inputs, the method including passing the channels received from the inputs to a wavelength selective switch (34) which is in communication with one or more drop transponders (43) for dropping at least one channels from the communications node (10, 90, 100).

According to a twelfth aspect the invention also provides a method of adding at least one channel to a communications node (10, 90, 100), the node arranged for routing a plurality of Wavelength Division Multiplexed (WDM) optical signals and having a plurality of inputs, the method including adding at least one channel to at least one add transponder (45) and passing it to one of the inputs of the communications node, and passing the at least one channel to a wavelength selective switch (34) which is in communication with an output of the communications node (10, 90, 100).

According to a thirteenth aspect the invention also provides a method of regenerating at least one channel of a WDM signal of a node (10, 90, 100), the node arranged for routing a plurality of Wavelength Division Multiplexed (WDM) optical signals and having a plurality of inputs, the method including passing at least one channel of the node to at least one regeneration transponder (96, 98) to regenerate it and then passing the regenerated channel to at least one wavelength selective switch (34) for onward transmission.

Other features of the invention will be apparent from the following description of preferred embodiments shown by way of example only in the accompanying drawings, in which;

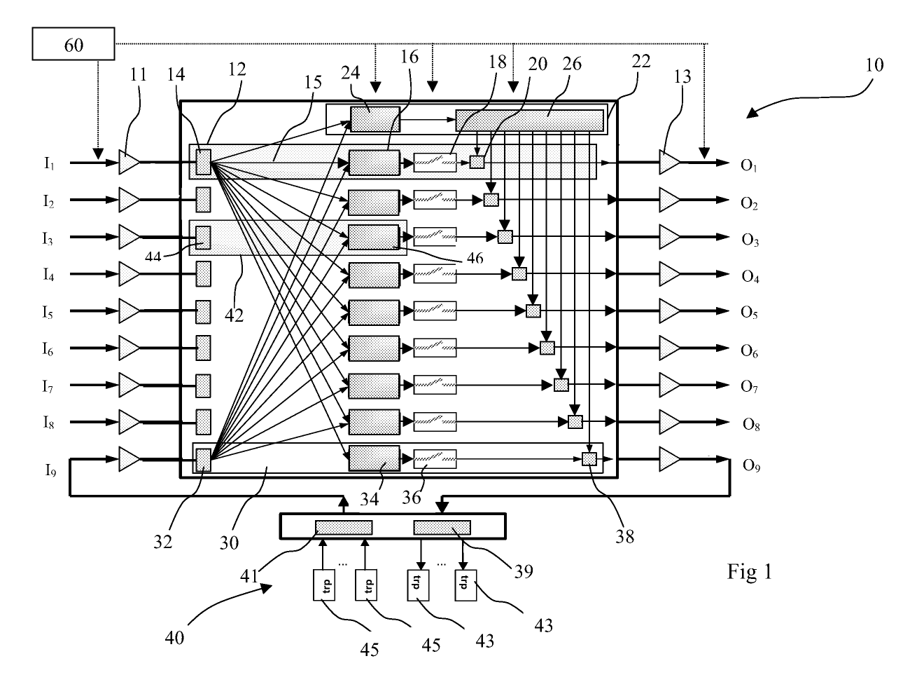

FIG. 1 is a schematic diagram of the architecture for a multi-port reconfigurable optical add-drop node according to a first embodiment of the invention;

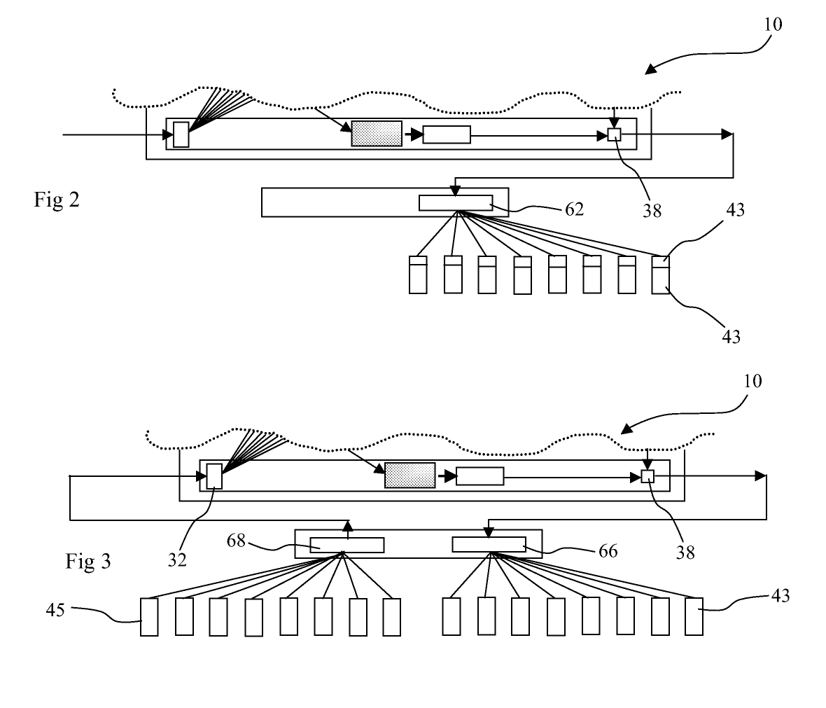

FIG. 2 is a schematic diagram of the architecture of drop functionality of the node of FIG. 1 according to a second embodiment;

FIG. 3 is a schematic diagram of the architecture of drop functionality of the node of FIG. 1 according to a third embodiment;

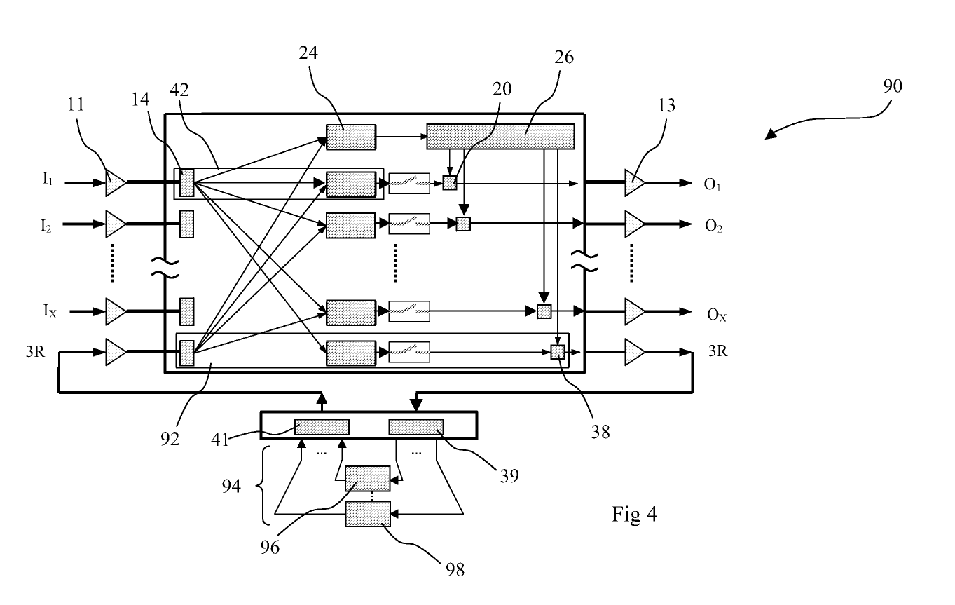

FIG. 4 is a schematic diagram of the architecture for a multi-port reconfigurable optical node having regeneration capability according to a second embodiment of the invention; and

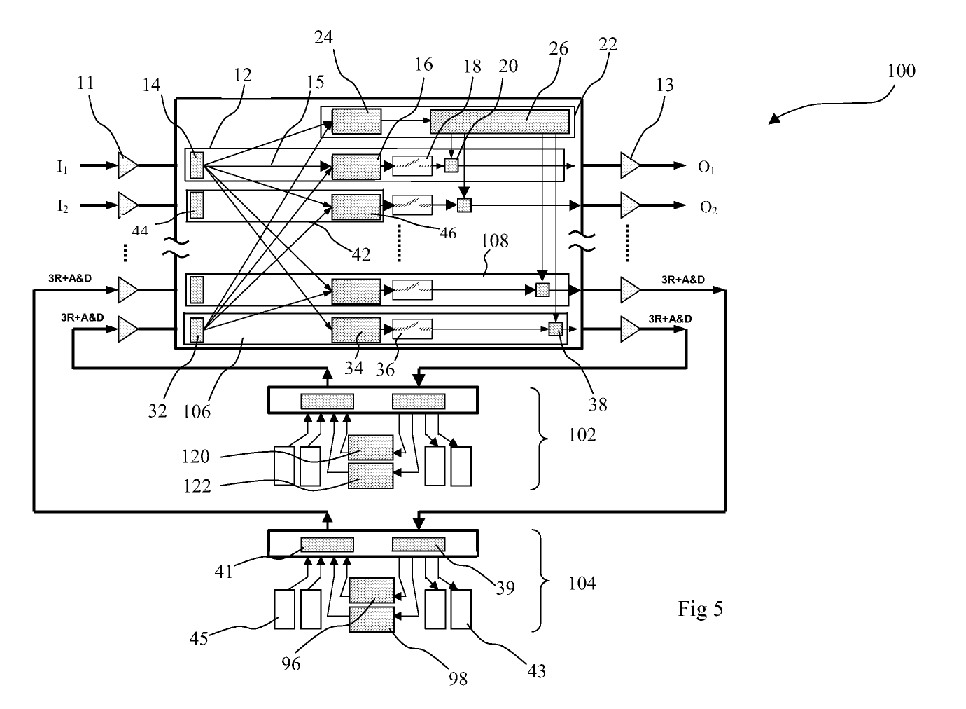

FIG. 5 is a schematic diagram of the architecture for a multi-port reconfigurable optical add-drop node having regeneration capability according to a third embodiment of the invention.

Referring to FIG. 1 there is shown a schematic diagram of the architecture for a multiport reconfigurable optical add-drop node according to a first embodiment of the invention, generally designated 10. The node 10 has eight input fibres I₁ to I₈, and eight output fibres O₁ to O₈. Each input fibre is for receiving traffic from an adjacent node. Each output fibre is for sending traffic to an adjacent node. Each input fibre I₁ to I₈ and output fibre O₁ to O₈ are arranged to carry a plurality of channels in the form of a Wavelength Division Multiplexed (WDM) optical signal such as a Coarse WDM (CWDM) or Dense WDM (DWDM) optical signal. A transport line unit 12 is arranged between each input fibre I₁ to I₈ and its respective output fibre O₁ to O₈ such that there are eight transport line units arranged between the input fibres I₁ to I₈ and the output fibres O₁ to O₈. In FIG. 1 only one transport line unit 12 is shown between the input fibre I₁ and the output fibre O₁ for the purposes of clarity. Furthermore for simplicity only a single WDM signal travelling West to East as seen in FIG. 1 will be discussed in detail. It will be appreciated that in the real-life node 10 there would be many WDM signals travel from East to West and from West to East, and the skilled person will know the requirements to achieve this using the principles of the embodiment of FIG. 1.

Each input fibre I₁ to I₈ has a respective input optical amplifier 11, and each output fibre O₁ to O₈ has a respective output optical amplifier 13. The amplifiers 11, 13 are chosen appropriately depending on the link requirements. Dual-stage amplifiers (DSA) with dispersion compensation module (DCM), or single stage amplifier (SSA), pre- and/or post-compensation, and/or gain flattening is used as required and the skilled person will know the requirements depending on the application. For example, to ensure dispersion compensation at the drop port, DCM must be used at the input amplifiers 11. The amplifiers on the pass-through directions are able to recover the WDM signal insertion loss of the node 10, and to amplify the channels to the correct launching power, without significantly affecting the signal quality (e.g. OSNR).

The transport line unit 12 includes a splitter 14, a Wavelength Selective Switch (WSS) 16, a shutter 18 and a 2×1 coupler 20. A suitable splitter 14 for the purposes of the embodiment of FIG. 1 is an array of ten optical fibres arranged in close contact as a cascade to split optically an incoming WDM signal on the input fibre I₁ into ten similar WDM signals on each of the optic fibres of the cascade. The skilled person will know the requirements for such a splitter 14. One fibre of the array is indicated at 15 leading from the splitter 14 to the WSS 16 of the transport line unit 12. The splitter 14 splits or to separates the incoming WDM signal (which may be composed of at least 80 wavelengths) into a plurality of WDM signals and passes them to each WSS in the plurality of line units. The WSS 16 operates as a demultiplexer to separate the input WDM signal into individual channels. In a similar manner the WDM signals from other splitters in other transport line units enter the WSS 16 of the transport line unit 12. The WSS 16 of the transport line unit 12 can switch any one or more channels of the eight WDM streams from input fibres I₁-I₈ towards any output fibre O₁ to O₈. This switching is arranged to be reconfigurable using a control plane of a network in which the node 10 is located. The skilled person will know the requirements for such a control plane. It will be appreciated that each WSS of the eight transport line units operates in a similar manner by accepting WDM streams from every input fibre I₁-I₈.

Once the WSS 16 of transport line unit 12 has separated the individual channels that are input using a demultiplexing function of the WSS 16, it then selectively switches the individual channels and then performs a multiplexing function to combine the required optical channels into a WDM signal for onward passage to the output fibre O₁. Downstream of the WSS 16 in the transport line unit 12 the shutter 18 and the coupler 20 operate in conjunction with a backup unit 22 of the node 10 as described below. During normal operation of the node 10, and without malfunction of any components of the node 10, the shutter 18 is in the closed position such that a WDM signal from the WSS 16 passes straight through to the coupler 20. During normal operation of the node 10, and without malfunction of any components of the node 10, the WDM signal from the WSS 16 passes straight through the coupler 20 and on to the output fibre O₁.

The backup unit 22 includes a backup WSS 24 and a backup switch 26. The backup WSS 24 is arranged to accept, for example eight WDM signals from the eight splitters in the eight transport line units, and one WDM signal from a splitter 32 in an add/drop line unit 30 described below. The backup switch 26 has a 1×9 configuration such that one WDM stream can be input from the backup WSS 24 and passed to any one of nine outputs of the backup switch 26. The backup switch 26 requires a number of outputs equal to the number of outputs O₁-O₉ of the node. Eight of the outputs of the backup switch 26 are for a respective output optic fibre O₁-O₈, and one of the outputs of the backup switch 26 is input to the add/drop line unit 30. When all of the WSSs of the node 10 are working properly, the backup unit 22 is idle and all WDM signals entering it are blocked by the backup switch 26. If a fault occurs with any one of the WSSs of the eight transport line units 12 the backup unit 22 is arranged to bypass the fault in the following way. If a fault occurs with the WSS 16 of the transport line unit 12, the WDM signal input to the backup WSS 24 is sent to the coupler 20 by the backup switch 26. This WDM signal is then sent to the output fibre O₁ for onward transmission. The shutter 18 operates to stop any unwanted signals that may be received from the failed WSS 16 and to avoid the unwanted signal from interfering with the WDM signal correctly selected by the backup WSS 24. The backup WSS 24 can also be followed by a shutter for the same reason, but generally this functionality can be conveniently realized by the backup switch 26. It will be appreciated that the backup switch 26 can be used to forward WDM signals to the correct output fibre O₁-O₈.

It will be readily apparent that a failure has occurred with a particular line unit using known ways of monitoring the channels at the inputs I₁-I₉ and outputs O₁-O₉. A way of readily identifying the failed line may be provided, such as a warning light, to visibly show where the failure has occurred so that it can be removed and replace.

It will be appreciated that a control unit 60 instructs the operation of the node 10 in a known manner. The control unit 60 is in communication with the various components of the node indicated by the dotted lines in FIG. 1. The control unit 60 has been omitted from FIGS. 4 and 3 for the purposes of clarity.

Since WSSs are active components that may be subject to faults it is recommended to provide protection from failures by redundancy using the backup unit 22. The arrangements of FIG. 1 provide such failsafe operation to make the node 10 more reliable. In this way the backup unit 22 operates as a failsafe device should there be a problem with one of the WSSs of any of the eight transport line units. Furthermore if two channels at the same wavelength enter the WSS 24 from two different inputs I₁-I₉, the architecture can suppress one of the two signals, and let the other pass. This is due to the functionality of the WSS itself, which can block any of the channels input to it.

FIG. 1 shows the add/drop line unit 30 between the add port I₉ and the drop port O₉. The add/drop line unit 30 allows channels of a WDM signal crossing the node 10 to be dropped from the node 10, or new channels to be added to the WDM signal crossing the node 10. More particularly, the node architecture permits adding or dropping of any channel from any input I₁ to I₈ or going to any output Oₗ-O₈. The add/drop line unit 30 comprises the add/drop splitter 32, an add/drop WSS 34, an add/drop blocker 36 and an add/drop 2×1 coupler 38. The add/drop line unit 30 operates in the same way as the line unit 12 described above but is instead used to add channels and/or data to the node 10 using a bank of transponders 40 using the known arrangements of a demultiplexer 39, drop transponders 43, add transponders 45, and a multiplexer 41. Should a fault occur with the add/drop WSS 34 the backup unit 22 is arranged as a bypass in the following way. The required channels to be dropped from the node 10 are selected from the WDM signals input to the backup WSS 24 and sent to the add/drop coupler 38 by the backup switch 26. The channels are then sent to the drop port O₉ to be dropped at the transponders 43 thereby bypassing the failed add/drop WSS 34. The add/drop shutter 36 operates to stop any signals that may be received from the failed add/drop WSS 34. In this manner the backup unit 22 operates as a failsafe device should there be a problem with the add/drop WSS 34. It will be appreciated that the backup WSS 24 can be used as a failsafe for dropping channels from the node, but that no such failsafe is required for adding channels to the node 10.

The node architecture of FIG. 1 provides redundancy in case of failure of one of the WSS 14. The node is also arranged to satisfy Optical Sub Network Connection Protection (OSNCP) relating to optical path protection and link protection. The skilled person will know the requirements for providing such protection.

A suitable WSS for the purposes of FIG. 1 is a Micro Electro Mechanical Systems (MEMS) device. In such a device an inbuilt demultiplexing function, usually based on an Arrayed Waveguide Grating (AWG), is used to spatially separate the individual wavelength channels of the WDM signal such that each channel is incident on a respective tiltable mirror of the MEM device. The orientation of the mirror determines whether the channel is directed towards a particular output. The WSS also includes an inbuilt multiplexing function (such as a spherical mirror) which combines the selectively switched channels into a WDM signal which is output from a respective output. Commercially available WSSs of this kind have an insertion loss that is almost independent of the number of fibre inputs. Such WSSs also have the capability of adjusting the optical power of the forwarded channel. This feature can be used to obtain substantially the same insertion power for each channel forwarded from many WSSs. The WSS 16 of FIG. 1 is readily commercially available in a configuration which can accept nine input WDM signals and output any one or more channels from one of the input WDM signals (such a switch may be termed a 1×9 configuration). It will be appreciated that other WSSs could be used that have different configurations such as a WSS having a 1×5 configuration which is also readily commercially available. The skilled person will know the arrangements for such a node using the principles of the embodiment of FIG. 1. The WSSs described above provide a uniform behaviour for each output fibre. They also have negligible cross talk between channels (<−35 dB), as well as a very high blocking extinction ratio (>25 dB). In the node 10 the channels launched from every output port can be equalized in power, which ensures the correct transmission of signals along long spans, and for many hops between successive nodes.

FIG. 1 also shows a basic line unit 42, which comprises a splitter 44 and a WSS 46. The basic line unit 42 is arranged as a removable unit from the node 10 so that it can be replaced easily with an equivalent unit should a fault occur with it. There are 9 basic line units in FIG. 1: one for each of the inputs I₁-I₉.

A node 10 so described which utilises WSS technology for switching and to provide a backup function ensures the required reliability of the node using a single backup WSS which protects all of the WSSs 44 in the line units 12. The maximum nodal degree is defined by the capacity of the backup WSS 24, which is connected with all of the input ports I₁-I₉. In the case of FIG. 1, the maximum ND of the node 10 is eight. The maximum number of line units that the node architecture can accommodate is therefore determined by the number of inputs of the WSSs 16, and by the number of outputs of the splitters 14.

It will be appreciated that if the reliability of the WSSs is poor (i.e. the WSSs suffer from non-negligible fault statistics, or if the nodal degree is very high), it is possible to use more than one backup WSS 24. Every backup WSS could serve all of the basic line units 42, or just a subset of them. Every backup WSS is followed by a backup switch 26 such that if every backup WSS protects all of the basic line units 42, the backup switch has a number of outputs equal to the number of basic line units 42 in the node. On the other hand, if every backup WSS protects only a subset of the basic line units 42, the backup switch associated with a particular subset has a number of output fibres equal to the number of basic line units 42 in the subset. It will be appreciated that if the splitters and WSSs used for the basic line unit are provided with spare capacity (i.e., they have unused output fibres and input fibres, respectively), and if the backup switch 26 also has spare output fibres, then it is possible to upgrade the nodal degree of the node 10 by merely plugging in additional line units 12 as required. This is achieved by connecting the additional line unit between the new input I_{X} and the new output O_{X} and connecting the spare output fibre of the backup switch 26 to the additional line unit.

A suitable WSS for use in the node 10 of FIG. 1 is described in “ROADM Subsystems and Technologies”, Optical Fibre Communication Conference, The Optical Society of America, Washington D.C. 2005. Such WSSs are known to the skilled person and will not be described further.

Referring back to FIG. 1 the transponders 40 for adding wavelengths to the node 10 have tuneable lasers, which provide the ability to dynamically change the wavelength of the channels added to the node 10. A node 10 so arranged provides maximum reconfigurability by allowing adding and dropping of channels at any wavelength, and also providing the ability to dynamically change the wavelength of added channels as required.

In an alternative embodiment the channels to be dropped from the node 10 can be forwarded to a plurality of transponders using a drop splitter 62 as shown in FIG. 2, and the transponders have the ability to select the desired channel to be dropped. This can be achieved with, for example, transponders 43 with tuneable filters 64.

In another embodiment a wavelength selective switch 66 can be used to select the channels to be received at the transponders 43 as shown in FIG. 3. Another wavelength selective switch 68 can be used to forward channels to the add/drop splitter 32 for onward transmission.

The node architecture of FIG. 1 for Adding and Dropping wavelengths does not permit the dropping of two or more channels simultaneously at the same wavelength entering from different paths. This is due to a hardware limitation of the node 10 which would cause contention at the WSS in the add/drop line unit 30, which would mean that only one channel would not be rejected by the WSS. This problem can be solved by a management plane or a control plane at a software level of the node 10 by checking the available wavelengths during the provisioning of the optical path. The skilled person will know the requirements for such provisioning.

Referring to FIG. 4 there is shown a schematic diagram of the architecture for a multi-port reconfigurable optical node having regeneration capability according to a second embodiment of the invention, generally designated 90. Like features to the embodiment of FIG. 1 are shown with like reference numerals. In FIG. 4 the node 90 has a regeneration unit 92 in place of the add/drop line unit 30 of FIG. 1. The regeneration unit 92 of FIG. 4 has the same components as the add/drop unit 30 and is configured to operate in the same way such that a WDM signal is passed from the regeneration unit 92 to the demultiplexer 39 and is input to the regeneration unit 92 from the multiplexer 41. However, instead of adding or dropping channels from the node 90, the regeneration unit 92 is configured to input channels to a bank of regeneration transponders 94 which are situated between the demultiplexer 39 and the multiplexer 41. The transponders 94 are capable of Reshaping, Regenerating and Retiming (3R) optical signals in a known manner. The skilled person will know the requirements for such 3R technology, which will not be described further. The 3R technology removes transmission impairments experienced by the signal using the series of transponders 94. In FIG. 4 two regeneration transponders are shown 96, 98 for regenerating two optical channels, but it will be appreciated that the number of transponders 94 can be increased to regenerate a larger number of optical channels as required. As described in FIG. 4 the 3R technology with transponders is uses optical-electrical-optical conversion. It could be also achieved instead of transponders using an all-optical device i.e. optical-optical-optical without conversion. A solution is also envisaged which performs the regeneration in the electrical domain. The skilled person will know the requirements for such optical-electrical-optical conversion.

In a mesh network the need to regenerate the optical signals may be necessary in order to extend the maximum path length that a WDM signal can be transmitted. It is envisaged that the regenerators can be placed in special nodes distributed as required in the network, or can be in every node in the network, or in many nodes in the network. For reconfigurability purpose, a regenerating node 90 is able to regenerate channels at any operable wavelength. The benefits of such a node 90 configured as described, and having regeneration capability is that the 3R transponders 94 can be shared between the basic line units 42 of the node 90, optionally between all of the basic line units 42. In this way any channel from any input port I₁-I_{X} can be regenerated by any of the 3R transponders 94, and can be re-directed to any output port O₁-O_{X}.

The add/drop line unit 30 of FIG. 1, and the regeneration unit 92 of FIG. 4 have a similar function, albeit that in the regeneration node 90 the channels are not actually dropped or added, but merely regenerated and reinserted. The main difference between the nodes 10 and 90 is that transponders 40 of FIG. 1 realizing the Add or Drop functionality are substituted by regeneration transponders 94. In this way a line unit can perform either function and it is envisages that a single line unit might perform both functions. For example a single line unit might be connected to add/drop transponders and regenerators whereby a control signal selects the function that the line unit will perform. This dual functionality will be discussed further in relation to FIG. 5.

The proposed solution for the implementation of regeneration using the node 90 of FIG. 4 has a limitation. The node 90 is not capable of regenerating two channels at the same wavelength running on separate optical paths. This may be the situation, for example, when a bidirectional connection is set up such that the same wavelength is generally used for both directions. The most logical way to manage regeneration of a bidirectional connection is to regenerate both directions at the same node, but due to the above-mentioned limitation this cannot be done with the node 90 of FIG. 4. To overcome this limitation it is necessary to use the node 100 according to the embodiment of FIG. 5.

In FIG. 5 there is shown a schematic diagram of the architecture for a multi-port reconfigurable optical add-drop node having regeneration capability according to a third embodiment of the invention, generally designated 100. Like features to the embodiments of FIGS. 1 and 3 are shown with like reference numerals. The node 100 of FIG. 5 has the capability of regenerating bidirectional traffic and adding or dropping traffic thereby solving contention issues in the communication node. This is achieved using two cards 102, 104, one for each direction so that the two directions of traffic can be handled separately. Each card 102, 104 has a respective line unit 106, 108. Each line unit 106, 108 has the same components as the add/drop unit 30 of FIG. 1 and the regeneration unit 92 of FIG. 4 and are configured to operate in the same way.

For simplicity only the operation of the card 104 of FIG. 5 will be described in detail. A WDM signal input to the card 104 from the line unit 108 is input to the demultiplexer of the card 104. Channels to be dropped at the node 100 are then dropped at the drop transponders 43 connected to the demultiplexer. Channels to be regenerated at the node 100 are regenerated at the regeneration transponders 96, 98. The regenerated channels are then re-inserted to the multiplexer 41 of the card 104. Channels to be added to the node 100 are added via the add transponders 45 which are also input to the multiplexer 41. The channels input to the multiplexer are then combined into a WDM signal, which is input to the line unit 106 for sending to any of the outputs O₁ to O_{X}.

It can be seen that a node capable of regenerating bidirectional traffic requires two line units, which must be reserved for regeneration of traffic in the two directions. In this way the cost and the capacity requirement of the regeneration node 100 is double that of the add-drop node 10 of FIG. 1, but this cost is offset by the functionality of the node 100 to provide add-drop capability thereby sharing the same cards. In this way the add-drop and regeneration functions are provided in a single line unit, without additional costs with respect to the architecture realizing only the add-drop function. This allows the distribution of regeneration capability in every node of the network such that every node that has add-drop functionality can also regenerate channels.

The cost of realising the regeneration and add-drop function in the node 100 of FIG. 5 is only one additional port with respect to the standard node 10 shown in FIG. 1 having only the add-drop functionality. The lasers of the regeneration transponder may be tuneable, which allows wavelength conversion at the node 100 whereby the frequency of input channels to the card 104 can be changed to a different frequency as required. In this way the node 100 has an increased flexibility and reconfigurability when compared to the add-drop node 10.

It will also be appreciated that if the constraint of regenerating bidirectional traffic with the same wavelength at the same node could be relaxed, every node in a network could having the functionality for regeneration, adding or dropping channels, and wavelength conversion functionalities at every line unit 30. This would lead to a very flexible network, since regenerators would be distributed throughout the network, albeit with additional cost. This could be achieved in a bidirectional transmission if either the two channels do not use the same wavelength and are regenerated at the same node, or the two channels with the same wavelength are regenerated at different nodes. In the latter case, it would also be possible to build a network where regeneration can be carried out in some dedicated nodes without constraints for bidirectional transmissions. However, regeneration can also be realized in any other node if the two traffic directions are separated and not on the same optical path. A further advantage provided by the node 100 when using wavelength conversion is that contentions are kept to minimum whilst minimising loss of data.

It will be appreciated by those skilled in the art that the proposed optical cross connects embodied by the nodes 10, 90, 100 exploit the properties of wavelength selective switches to realise flexible, reconfigurable and reliable network nodes. The architecture of the nodes 10, 90, 100 is scalable because the nodal degree can be changed by simply adding or removing line units. It will also be appreciated that the proposed nodes 10, 90, 100 can implement broadcasting, because all the entering channels at the inputs I₁-I₉ are distributed to every WSS 16 associated with every output port O₁-O₉. Such broadcasting also has the advantage of providing both link protection and path protection (Optical Sub-Network Connection Protection, OSNCP) without further additions to the node 10, 90, 100 architecture. The skilled person will know the requirements to provide such protection.

1-43. (canceled)

44. A communications node for routing a plurality of Wavelength Division Multiplexed (WDM) optical signals, the node comprising:
a plurality of inputs and a plurality of outputs, each input associated with a respective output;
a line unit disposed between each associated input and output, each line unit comprising:
a Wavelength Selective Switch (WSS); and
a splitter configured to split an incoming WDM signal into a plurality of WDM signals, and to pass the WDM signals to each WSS in the line units, each WSS configured to selectively route one or more channels of received WDM signals to its associated output.

45. The communications node of claim 44 wherein at least one of the line units has an output to one or more drop transponders to drop channels from the node.

46. The communications node of claim 44 wherein at least one of the line units comprises an input from one or more add transponders to add one or more channels to the node.

47. The communications node of claim 46 wherein the one or more add transponders are configured to change a wavelength of the one or more channels added to the node.

48. The communications node of claim 47 wherein the one or more add transponders include one or more tuneable lasers to change the wavelength of the one or more added channels.

49. The communications node of claim 44 further comprising:
at least one backup unit having a backup WSS in communication with a backup switch;
each line unit further comprising a coupler disposed between its corresponding WSS and its respective associated output; and
the backup unit configured to:
direct WDM signals from each WSS of the line units to the backup WSS, and the backup switch comprising a plurality of outputs, each of which is connected to the coupler of a respective one of the line units; and
upon a failure of a WSS in one of the line units, route the WDM signal associated with the failed WSS to the coupler associated with the failed WSS using the backup switch.

50. The communications node of claim 49 wherein each line unit includes a shutter disposed between its associated WSS and its associated coupler to block selected signals from the failed WSS.

51. The communications node of claim 49 wherein an output of the of the backup switch is in communication with the line unit associated with adding or dropping channels from the node to permit the backup unit to bypass a failure of the WSS associated with the line unit.

52. The communications node of claim 49 wherein the backup switch blocks the WDM signals entering the backup WSS when each WSS of the node is functioning correctly.

53. The communications node of claim 50 wherein a backup shutter disposed between the backup WSS and the backup switch blocks the WDM signals entering the backup WSS when each WSS of the node is functioning correctly.

54. The communications node of claim 49 wherein the at least one backup unit serves one or more of the line units.

55. The communications node of claim 49 wherein each coupler has a 2×1 configuration.

56. The communications node of claim 44 wherein each line unit includes a basic line unit comprising the splitter and the WSS of that line unit, and wherein the basic line unit is interchangable with another basic line unit.

57. The communications node of claim 56 wherein each basic line unit comprises a cartridge that can be inserted and removed.

58. The communications node of claim 44 further including a control plane configured to check the available wavelengths during provisioning of an optical path between the plurality of inputs and the plurality of outputs to permit two or more channels at the same wavelength and entering the node substantially simultaneously at different inputs, to be dropped.

59. The communications node of claim 44 wherein each WSS is reconfigurable using a control plane of a network in which the node is located.

60. The communications node of claim 44 wherein the splitter and the WSS of at least one of the line units includes a redundant output and input, respectively, such that the node is upgradeable by adding a line unit by connecting them to the redundant output and input.

61. The communications node of claim 44 wherein a first line unit comprises an output communicatively connected to at least one first regeneration transponder, the at least one first regeneration transponder being configured to regenerate at least one channel of a first WDM signal output from the first line unit and including an output communicatively connected to one of the line units.

62. The communications node of claim 61 wherein the at least one first regeneration transponder is configured to function using Reshaping, Regenerating, and Retiming (3R) technology.

63. The communications node of claim 61 wherein the at least one first regeneration transponder is configured to perform wavelength conversion to change the wavelength of the regenerated channels at the node.

64. The communications node of claim 63 wherein the at least one first regeneration transponder comprises a tuneable laser to perform the wavelength conversion changing the wavelength of the regenerated channels at the node.

65. The communications node of claim 61 wherein the output of the first line unit is in communication with one or more drop transponders to permit the first line unit to regenerate channels and to drop channels from the node.

66. The communications node of claim 61 wherein the input to the first line unit is in communication with one or more add transponders to permit the first line unit to regenerate channels traffic and to add channels to the node.

67. The communications node of claim 61 wherein a second line unit comprises an output communicatively connected to at least one second regeneration transponder, the at least one second regeneration transponder being configured to regenerate at least one channel of a second WDM signal output from the second line unit to permit the node to substantially simultaneously regenerate two channels at the same wavelength and having an output communicatively connected to one of of line units.

68. The communications node of claim 67 wherein the at least one second regeneration transponder is configured to operate using Reshaping, Regenerating, and Retiming (3R) technology.

69. The communications node of claim 67 wherein the at least one second regeneration transponder has a tuneable laser to change the wavelength of the regenerated channels at the node.

70. The communications node of claim 67 wherein the output of the second line unit is in communication with one or more drop transponders to permit the second line unit to substantially simultaneously regenerate two channels at the same wavelength, and to drop channels from the node.

71. The communications node of claim 67 wherein the input to the second line unit is in communication with the add transponders to permit the second line unit to substantially simultaneously regenerate two channels at the same wavelength, and to add channels to the node.

72. The communications node of claim 44 wherein at least one of the plurality of inputs has a respective input optical amplifier.

73. The communications node of claim 44 wherein at least one of the plurality of outputs has a respective output optical amplifier.

74. The communications node of claim 44 wherein at least one WSS is a switching device.

75. The communications node of claim 74 wherein the switching device comprises at least one of a Micro Electro Mechanical Systems (MEMS) device and a Liquid Crystal device.

76. The communications node of claim 44 wherein an indicator is provided on one of a failed basic line unit and the communications node to indicate that a failure has occurred.

77. The communications node of claim 76 wherein the indicator is a warning light.

78. A communications network comprising:
a communications node configured to route a plurality of Wavelength Division Multiplexed (WDM) optical signals, the node comprising:
a plurality of inputs and a plurality of outputs, each input associated with a respective output;
a line unit disposed between each associated input and output, each line unit comprising:
a Wavelength Selective Switch (WSS); and
a splitter configured to split an incoming WDM signal into a plurality of WDM signals, and to pass the WDM signals to each WSS in the line units, each WSS configured to selectively route one or more channels of received WDM signals to its associated output.

79. A method of dropping channels from a communications node, the method comprising:
operating a communications node configured to route a plurality of Wavelength Division Multiplexed (WDM) optical signals, the node comprising a plurality of inputs and a plurality of outputs, each input being associated with a respective one of the outputs, and each associated input and output including a line unit between them, each line unit comprising a splitter and a Wavelength Selective Switch (WSS), wherein the splitter is configured to split an incoming WDM signal into a plurality of WDM signals, and to pass the incoming WDM signals to each WSS in the line units, and wherein each WSS is configured to selectively route one or more channels of its received WDM signals to its associated output, and wherein at least one line unit has an output communicatively connected to one or more drop transponders; and
dropping one or more channels from the node at the one or more drop transponders.

80. A method of adding channels from a communications node, the method comprising:
operating a communications node configured to route a plurality of Wavelength Division Multiplexed (WDM) optical signals, the node comprising a plurality of inputs and a plurality of outputs, each input being associated with a respective one of the outputs, and each associated input and output including a line unit between them, each line unit comprising a splitter and a Wavelength Selective Switch (WSS), wherein the splitter is configured to split an incoming WDM signal into a plurality of WDM signals, and to pass the incoming WDM signals to each WSS in the line units, and wherein each WSS is configured to selectively route one or more channels of its received WDM signals to its associated output, and wherein at least one line unit has an input from one or more add transponders; and
adding one or more channels to the node at the one or more add transponders.

81. A method of regenerating at least one channel of a Wavelength Division Multiplexed (WDM) signal of a communications node, the method comprising:
operating a communications node configured to route a plurality of WDM optical signals, the node comprising a plurality of inputs and a plurality of outputs, each input associated with a respective output, each associated input and output having a line unit between them, each line unit including a splitter and a Wavelength Selective Switch (WSS), wherein the splitter is configured to split an incoming WDM signal into a plurality of WDM signals and to pass them to each WSS in the line units, each WSS being configured to selectively route one or more channels of its received WDM signals to its associated output, and wherein a first line unit has an output to at least one first regeneration transponder;
communicatively connecting an output of the at least one first regeneration transponder to one of the line units; and
regenerating at least one channel of a first WDM signal output from the first line unit.

82. A method of upgrading a communications node, the method comprising:
operating a communications node configured to route a plurality of Wavelength Division Multiplexed (WDM) optical signals, the node comprising a plurality of inputs and a plurality of outputs, each input associated with a respective output, each associated input and output having a line unit between them, each line unit including a splitter and a Wavelength Selective Switch (WSS), wherein the splitter is configured to split an incoming WDM signal into a plurality of WDM signals and to pass them to each WSS in the line units, each WSS being configured to selectively route one or more channels of its received WDM signals to its associated output, and wherein each line unit includes a basic line unit which comprises the splitter and the WSS of that line unit;
providing the splitter and the WSS of at least one of the line units with redundant outputs and inputs, respectively; and
upgrading the node with an additional line unit by connecting it to the redundant outputs and inputs.

83. A computer readable medium having logic to be executed by a computer processor of a communications node stored thereon, the communications node configured to route a plurality of Wavelength Division Multiplexed (WDM) optical signals and comprising a plurality of inputs and a plurality of outputs, each input associated with a respective output, each associated input and output having a line unit between them, each line unit including a splitter and a Wavelength Selective Switch (WSS), wherein the splitter is configured to split an incoming WDM signal into a plurality of WDM signals and to pass them to each WSS in the line units, each WSS being configured to selectively route one or more channels of its received WDM signals to its associated output, wherein at least one line unit has an output to one or more drop transponders, the logic configured to cause the node to:
drop one or more channels from the node at the one or more drop transponders.

84. A computer readable medium having logic to be executed by a computer processor of a communications node stored thereon, the communications node configured to route a plurality of Wavelength Division Multiplexed (WDM) optical signals and comprising a plurality of inputs and a plurality of outputs, each input associated with a respective output, each associated input and output having a line unit between them, each line unit including a splitter and a Wavelength Selective Switch (WSS), wherein the splitter is configured to split an incoming WDM signal into a plurality of WDM signals and to pass them to each WSS in the line units, each WSS being configured to selectively route one or more channels of its received WDM signals to its associated output, wherein at least one line unit has an input from one or more add transponders, the logic configured to cause the node to:
add one or more channels to the node at the one or more add transponders.

85. A computer readable medium having logic to be executed by a computer processor of a communications node stored thereon, the communications node configured to route a plurality of Wavelength Division Multiplexed (WDM) optical signals and comprising a plurality of inputs and a plurality of outputs, each input associated with a respective output, each associated input and output having a line unit between them, each line unit including a splitter and a Wavelength Selective Switch (WSS), wherein the splitter is configured to split an incoming WDM signal into a plurality of WDM signals and to pass them to each WSS in the line units, each WSS being configured to selectively route one or more channels of its received WDM signals to its associated output, wherein a first line unit has an output to at least one first regeneration transponder, the logic configured to cause the node to:
regenerate at least one channel of a first WDM signal output from the first line unit at the first regeneration transponder, wherein the regeneration transponder comprises an output to one of the line units.

86. A method of compensating for failure in a communications node, the method comprising:
operating a communications node configured to route a plurality of Wavelength Division Multiplexed (WDM) optical signals and including a plurality of inputs and a plurality of outputs, each input associated with a respective output, each associated input and output having a line unit between them, each line unit including a splitter and a Wavelength Selective Switch (WSS), wherein the splitter is configured to split an incoming WDM signal into a plurality of WDM signals and to pass them to each WSS in the line units, the node further including at least one backup unit having a backup WSS in communication with a backup switch, each line unit being further provided with a coupler between its WSS and its respective associated output, the backup WSS being configured to accept WDM signals from each WSS of the line units, the backup switch having a plurality of outputs each of which is connected to the coupler of a respective one of the plurality of line units;
configuring each WSS to selectively route one or more channels of its received WDM signals to its associated output;
detecting a failure of the WSS in one of the line units; and
configuring the node to route the WDM signal associated with the failed WSS to the coupler of the associated failed WSS using the backup switch.
